(19) United States
(12) Patent Application Publication
(10) Pub. No.: US 2025/0064209 A1
(43) Pub. Date: Feb. 27, 2025

(54) SYNCHRONIZATION ROD FOR FURNITURE DRIVES

(71) Applicant: Julius Blum GmbH, Hoechst (AT)

(72) Inventor: Olaf ISELE, Lustenau (AT)

(21) Appl. No.: 18/940,187

(22) Filed: Nov. 7, 2024

Related U.S. Application Data
(63) Continuation of application No. PCT/AT2023/060112, filed on Apr. 5, 2023.

(30) Foreign Application Priority Data
May 13, 2022 (AT) A 50344/2022

(51) Int. Cl. A47B 88/45; E05D 11/00; E05D 15/46

(52) U.S. Cl. CPC A47B 88/45; E05D 11/0081; E05D 15/46; A47B 2210/0078; E05Y 2201/62; E05Y 2900/20

(57) ABSTRACT

A synchronization rod for furniture drives for the synchronous moving of movable furniture parts, includes a coupling portion for connection to a furniture drive and a synchronization portion along a length of the synchronization rod, more particularly arranged between two opposite coupling portions. The synchronization portion, as seen in a cross-section taken orthogonally to the length, has a first outer contour portion in the form of a circular segment and a further outer contour portion, preferably adjacent to the first outer contour portion, having a geometry in a form that is not a circular segment. The circular segment comprises an angular range of between 250° and 330° and/or an angular range of between 180° and 350°, and the further outer contour portion is arranged exclusively on one side of the synchronization rod.

The present application is a continuation of International Application PCT/AT2023/060112 filed on Apr. 5, 2023. Thus, all of the subject matter of International Application PCT/AT2023/060112 is incorporated herein by reference.

### BACKGROUND OF THE INVENTION

The invention relates to a synchronization rod for furniture drives for the synchronous moving of movable furniture parts, comprising at least one coupling region for connection to a furniture drive and a synchronization region along a longitudinal extension of the synchronization rod, in particular arranged between two opposite coupling regions. Furthermore, the invention relates to an arrangement of at least two furniture drives, each with a drive device and at least one actuating arm for the synchronized movement of a movable furniture part and at least one such synchronization rod. Furthermore, the invention relates to a piece of furniture with a furniture body and at least one such arrangement as well as a method for producing a synchronization region of such a synchronization rod. Such a synchronization rod with a round cross-sectional profile is already known from EP 2 491 213 B1.

A disadvantage of the prior art is that during the extrusion process of the synchronization region of the synchronization rod, the inner contour intended for synchronization is twisted because the extruded raw material has a very long longitudinal extension and the raw material flowing through the extrusion mold rotates during extrusion. As a result, precise and proper synchronization of furniture drives cannot be guaranteed. Due in particular to component tolerances, a high proportion of synchronization rods must be rejected as scrap.

The visual appearance of synchronization rods is of essential importance for a furniture operator, whereby the visual or aesthetic impression of non-round synchronization regions has a diminishing effect in this regard.

### SUMMARY OF THE INVENTION

The object of the present invention is therefore to provide a synchronization device which is improved compared to the prior art and a method for producing the synchronization region, in which the disadvantages of the prior art are at least partially eliminated, and which are characterized in particular by a reduced twisting of the inner contour for precise synchronization of furniture drives with an aesthetically pleasing design.

Therefore according to the invention, the synchronization region in a cross-section orthogonal to the longitudinal extension has a first outer contour portion in the form of a circular segment and at least one further outer contour portion, preferably adjacent to the first outer contour portion, in the form of a geometry deviating from a circular segment. The circular segment comprises:
an angular range of between 250° and 330°, and/or
an angular range of between 180° and 350°, wherein the further outer contour portion is arranged exclusively on one side of the synchronization rod.

This makes it possible to at least reduce or inhibit, preferably completely prevent, a twisting of the synchronization region—in particular of an inner contour used for synchronization—, during the extrusion process for producing the synchronization rod and to provide a precise coordination of furniture drives for the synchronized movement of movable furniture parts.

In addition, there is the positive property that the remaining first outer contour portion can provide the operator of the synchronization rod with the impression that it is a round synchronization region, since the positioning of the at least one further outer contour portion can point towards a rear side of the furniture drive in an open position of the actuating arms and can be covered by the movable furniture part in the closed position of the actuating arms.

The cross-section of the synchronization region therefore enables a dual function of reducing undesirable effects caused by manufacturing and maintaining the appearance of a round synchronization region. The position of the at least one further outer contour portion can be automatically adapted to the positioning of the actuating arm.

Particularly preferably, the synchronization rod comprises a one-sided flattening in cross-section and/or a circular segment with an angular range between 190° and 350° in order to provide the impression of a circular synchronization rod in an operating position of the synchronization rod from slightly different viewing angles and/or to effectively utilize the advantage of reducing the twisting.

As stated at the outset, protection is also sought for an arrangement of at least two furniture drives, each with a drive device and at least one actuating arm for the synchronized movement of a movable furniture part and at least one such synchronization rod. The at least two furniture drives in the use position comprise a viewing region and a rear side and the actuating arms are movable between an open position and a closed position. The at least one further outer contour portion in the open position of the actuating arms points in the direction of the rear side and/or in the closed position in the direction of the viewing region.

As stated at the beginning, protection is also sought for a piece of furniture with a furniture body and at least one such arrangement.

As stated at the outset, protection is also sought for a method for producing a synchronization region of such a synchronization rod, wherein the following steps are carried out:
providing an extrusion mold with a first die contour in the form of a circular segment and at least one further die contour, in particular adjacent to the first die contour, wherein the at least one further die contour has a geometry that differs from the first die contour, preferably a straight geometry; and
extruding a raw material through the extrusion mold and cutting to length to form the synchronization region.

The at least one further outer contour portion deviating from the round shape can be formed via the further die contour, whereby a twisting of the synchronization region is reduced in the sense of a guide contour. This allows the synchronization teeth of the synchronization rod to be used for synchronization in a positionally accurate manner over the longitudinal extension of the synchronization rod.

According to an advantageous embodiment of the invention, the at least one further outer contour portion comprises a straight line and/or is designed as at least one straight line adjacent to the circular segment.

At least one straight line effectively prevents twisting of the synchronization region, wherein the straight line can serve as a support in the manufacturing process, which can counteract undesirable rotation in the extrusion mold.

Advantageously, the cross-section of the synchronization region is mirror-symmetrical and/or has exclusively a 360° rotational symmetry, preferably 180° rotational symmetry.

In general, only a region of the cross-section that deviates from a circular shape is required so that this region can act as an inhibition region to reduce twisting of the synchronization region.

It has proven to be advantageous that the at least one further outer contour portion comprises a corrugation, preferably in a wave-shaped or polygonal shape.

In general, other shapes deviating from the circular cross-section are also conceivable.

According to an advantageous embodiment of the invention, the synchronization region comprises at least one, preferably polygon-like, inner contour, preferably with at least one bulge, for synchronizing the furniture drives, wherein the inner contour is mirror-symmetrical and/or has exclusively a 360° rotational symmetry, preferably 180° rotational symmetry.

The inner contour can be used for synchronization, wherein an asymmetrically designed inner contour can be used to particularly effectively reduce twisting in the synchronization region. It has proven to be advantageous that the at least one inner contour and the cross-section of the synchronization region are designed asymmetrically over the entire synchronization region.

By using asymmetrical inner and outer contours, unwanted deflection of material from the synchronization region in one plane of the cross-section along the synchronization region can be particularly effectively restricted.

An advantageous variant of the present invention consists in that the at least one coupling region comprises a preferably wave-shaped coupling contour and/or a plate-shaped coupling device. Preferably, the at least one coupling contour is mirror-symmetrical and/or has exclusively a 360° rotational symmetry, preferably 180° rotational symmetry.

With an asymmetrical coupling contour, synchronization can be carried out with particularly high accuracy—in particular, in combination with an asymmetrical inner and/or outer contour.

It is particularly preferred that the synchronization region, preferably the synchronization rod, is extruded.

Extrusion has proven to be particularly advantageous for synchronization rod profiles, in particular hollow ones. A plurality of synchronization rods can be manufactured from one raw material, and specific dimensions of synchronization rods can be achieved, preferably subsequently.

In one exemplary embodiment of the invention, the circular segment comprises an angular range between 180° and 350°, preferably between 250° and 330°, particularly preferably between 290° and 320°.

If the angular range of the circular segment is smaller, twisting is prevented to a greater extent. If the angular range of the circular segment is larger, a covering of the at least one further outer contour portion in the open position of the actuating arms can be obtained more easily from different viewing angles.

According to a preferred embodiment of the invention, the at least one straight line is designed in the form of a polygonal line, preferably approximating a circular contour and/or as an alternating polygonal line.

In principle, a straight line—or even an elliptical shape, for example—is sufficient to reduce the twist of the synchronization region. From a manufacturing point of view, however, it may be advantageous to provide a plurality of adjacent or spaced straight lines.

It has proven to be advantageous that the at least one straight line in the longitudinal extension forms a flattening of the synchronization region at least in some regions, preferably completely.

If the flattening is present over the entire longitudinal extension of the synchronization region, the twisting can be inhibited not only locally.

Furthermore, preferably the raw material is pre-tempered in a preparatory step and/or that the extruded raw material is stretched, preferably via tongs, and/or aged in an oven before cutting to length.

Flow properties can be adjusted via pre-tempering. Material-specific characteristics can be adjusted through aging. By stretching, bending caused during production can be reduced.

In a further embodiment, the extrusion mold for extrusion can comprise a first die and at least one second die separate from the first die. Preferably, the at least one second die comprises a core which projects at least partially into the first die, preferably with the same horizon of the dies and/or to form a substantially identical flow velocity of the raw material over the dies.

Two matrices (often referred to as flying matrices) allow complex geometries to be generated within the synchronization region, wherein raw material flows together across the two matrices to form the synchronization region. The core can support this manufacturing process.

### BRIEF DESCRIPTION OF THE DRAWINGS

Further details and advantages of the present invention are explained in more detail below with reference to the drawings, in which:

FIG. 1a, 1b show a piece of furniture with an arrangement with a synchronization rod according to a preferred exemplary embodiment in a perspective view with two enlarged detail sections of a connection of the synchronization rod with a furniture drive,

FIG. 2 shows the piece of furniture with the synchronization rod according to the embodiment of FIG. 1b in perspective view with an enlarged detail section of the connection of the synchronization rod with hidden movable furniture part and hidden cover,

FIG. 3 shows the piece of furniture with the synchronization rod according to the embodiment of FIG. 1a in a view from the front and a sectional view from the side,

FIG. 4 shows the piece of furniture with the synchronization rod according to the embodiment of FIG. 1a in a sectional view from the side in the open position with an enlarged detail section in the region of the synchronization rod,

FIG. 5 shows the piece of furniture with the synchronization rod according to the embodiment of FIG. 1a in a sectional view from the side in the open position with an enlarged detail section in the region of the synchronization rod,

FIG. 6 shows the piece of furniture with the synchronization rod according to the embodiment of FIG. 1b in perspective view with hidden furniture part and hidden cover and an enlarged detail section of the connection of the synchronization rod with the furniture drive,

FIG. 7 shows the furniture drive with the synchronization rod according to the embodiment of FIG. 1b in a view from the side with an enlarged detail section of the synchronization rod and a corresponding receptacle on the furniture drive,

FIG. 8 shows the furniture drive with the synchronization rod according to the embodiment of FIG. 1b in a perspective view with an enlarged detail section of a coupling region of the synchronization rod,

FIG. 9 shows an enlarged detail section of the receptacle on the furniture drive in perspective view,

FIG. 10a, 10b show an illustration of a method not according to the invention for producing a synchronization rod by extrusion in perspective view,

FIG. 11 shows the illustration of the method not according to the invention according to FIG. 10b in a view from above with three sectional views and three enlarged detail sections,

FIG. 12a, 12b show an illustration of a manufacturing process according to the invention by extrusion in perspective view, and

FIG. 13 shows the illustration of the method according to the invention according to FIG. 12b in a view from above with three sectional views and three enlarged detail sections.

### DETAILED DESCRIPTION OF THE INVENTION

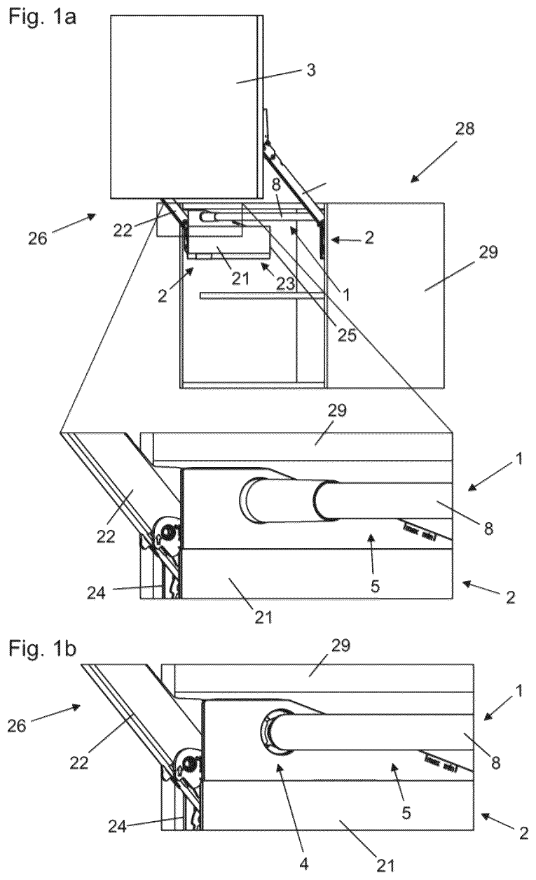

FIG. 1a shows a piece of furniture 28 with a furniture body 29 and at least one arrangement of two furniture drives 2, each with a drive device 21 and an actuating arm 22 for the synchronized movement of a movable furniture part 3.

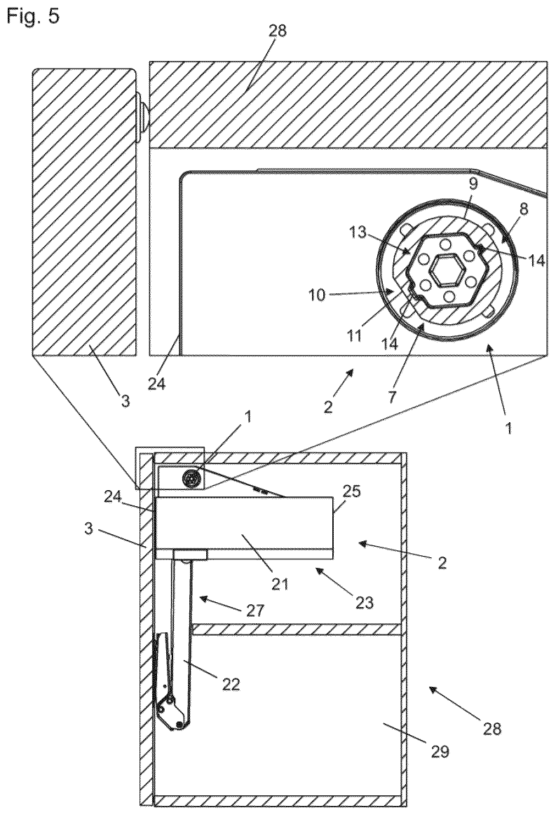

The arrangement comprises a synchronization rod 1. The two furniture drives 2 are arranged in use position 23 and have a viewing region 24 and a rear side 25. The actuating arms 22 are movable between an open position 26 and a closed position 27 (see FIG. 5).

In FIG. 1b, the connection region of the synchronization rod 1 with the furniture drive 2 is visible, since a cover of the synchronization rod is removed for illustration purposes.

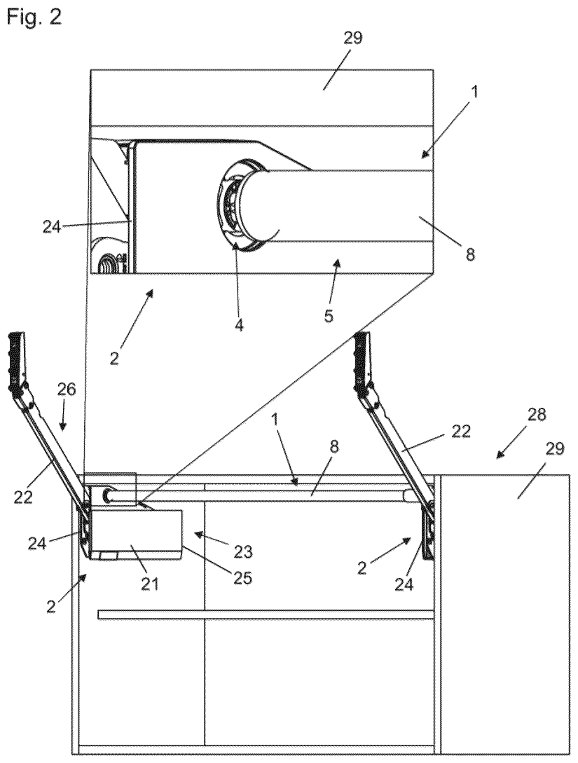

FIG. 2 shows the piece of furniture 28 with the actuating arms 22 in the open position 26 without a movable furniture part 3 and cover of the synchronization rod 1. The synchronization rod 1 synchronizes the movement of the two furniture drives 2.

The synchronization rod 1 for the furniture drives 2 for the synchronous movement of the movable furniture parts 3 comprises two coupling regions 4 for connection to a furniture drive 2 each via a receiving region designed corresponding to the coupling region 4 in a mechanical drive unit, wherein in general an electric drive unit can be used in addition or alternatively.

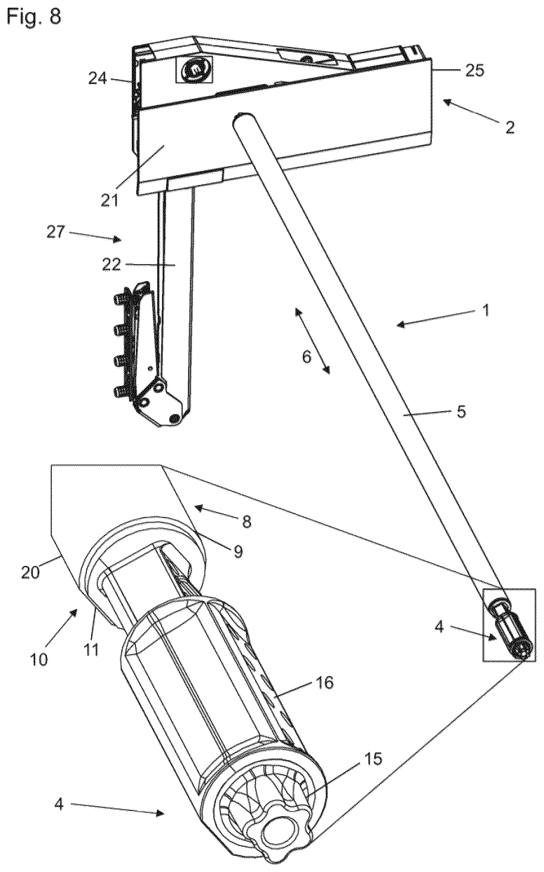

The synchronization rod 1 comprises a synchronization region 5 along a longitudinal extension 6 (see FIG. 8) of the synchronization rod 1, which is arranged between two opposite coupling regions 4.

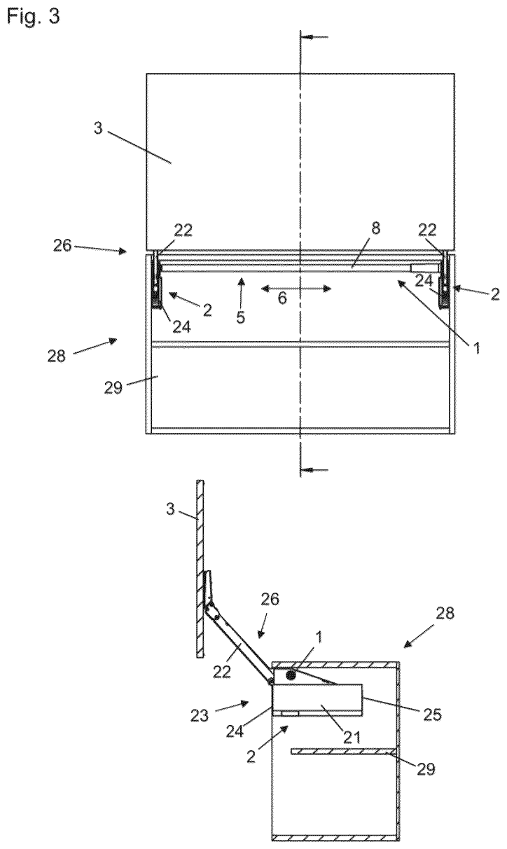

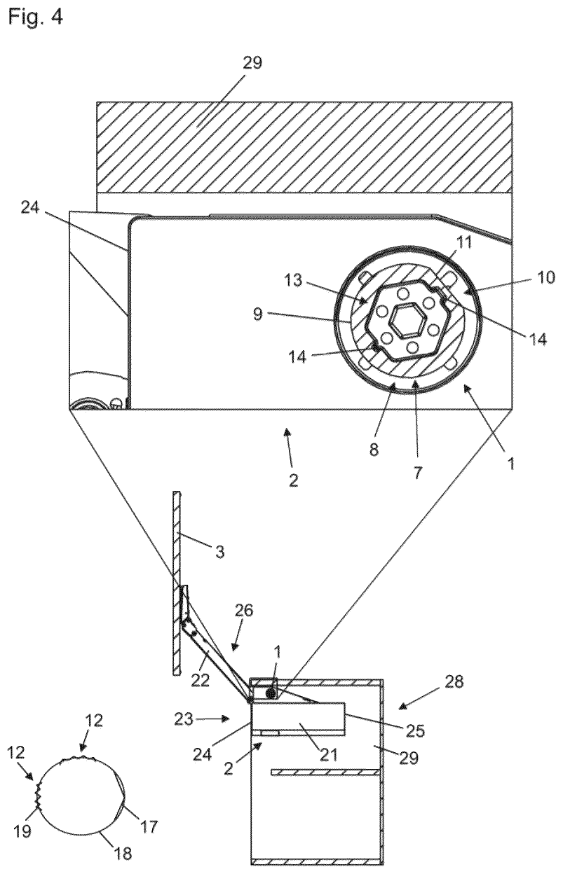

FIG. 3 shows the piece of furniture 28 in a view from the front (with a remaining cover of the synchronization rod 1), wherein below a sectional view through the synchronization rod 1 in the synchronization region 5 can be seen, which is shown enlarged in FIG. 4.

In FIG. 4 it can be seen that the synchronization region 5 in the cross-section 7 orthogonal to the longitudinal extension 6 has a first outer contour portion 8 in the form of a circular segment 9 and a further outer contour portion 10 adjacent to the first outer contour portion 8 in the form of a geometry deviating from a circular segment 9.

The further outer contour portion 10 points in the open position 26 of the actuating arms 22 in the direction of the rear side 25 of the furniture drives 2 and in the closed position 27 in the direction of the viewing region 24 of the furniture drives 2, so that the usual aesthetically pleasing appearance of the synchronization rod 1 is visible to a user of the furniture drives 2 and the further outer contour portion 10 deviating from the circular segment 9, which counteracts the twisting in the manufacturing process, remains hidden for a user looking at the viewing region 24.

The further outer contour portion 10 is designed in the form of a straight line 11 adjacent to the circular segment 9, wherein in general a plurality of straight lines 11 or other contours along the synchronization region 5 are possible.

In the schematic representation at the bottom left, further conceivable geometries of the further outer contour portion 10 are shown, wherein the further outer contour portion 10 is designed as a wave-shaped corrugation 12 at the upper end of an imaginary circular contour 18, as a polygonal corrugation 12 at the left end of the imaginary circular contour 18 and as a straight line 11 in the form of a polygonal line 17 which is approximated to the imaginary circular contour 18. The polygonal corrugation 12 is in the form of an alternating polygonal line 19. Preferably, only one such further outer contour portion 10 is used, wherein in general several different or similar outer contour portions 10 can also be combined, which are arranged, for example, at different positions on the cross-section 7 or adjacent to one another.

FIG. 5 shows the actuating arms 22 in the closed position 27, wherein the straight line 11 points in the direction of the viewing region 24, which is covered by the movable furniture part 3.

In the enlarged detail section it can be seen that the cross-section 7 of the synchronization region 5 is mirror-symmetrical and has exclusively a 360° rotational symmetry. In general, it is conceivable to provide, for example, a 180° rotational symmetry.

The straight line 11 extends over an angular range of approximately 55°, wherein the adjacent circular segment 9 of the first outer contour portion 8 has an angular range between 290° and 320°. The extension of the circular segment 9 is generally not limited to a specific angular range, wherein, for example, straight lines 11 can also be spaced apart by further circular segments 9.

The synchronization region 5 comprises a polygonal inner contour 13 with two bulges 14 for synchronizing the furniture drives 2.

The inner contour 13 is mirror-symmetrical and has exclusively a 360° rotational symmetry, although in general a 180° rotational symmetry is also possible, for example.

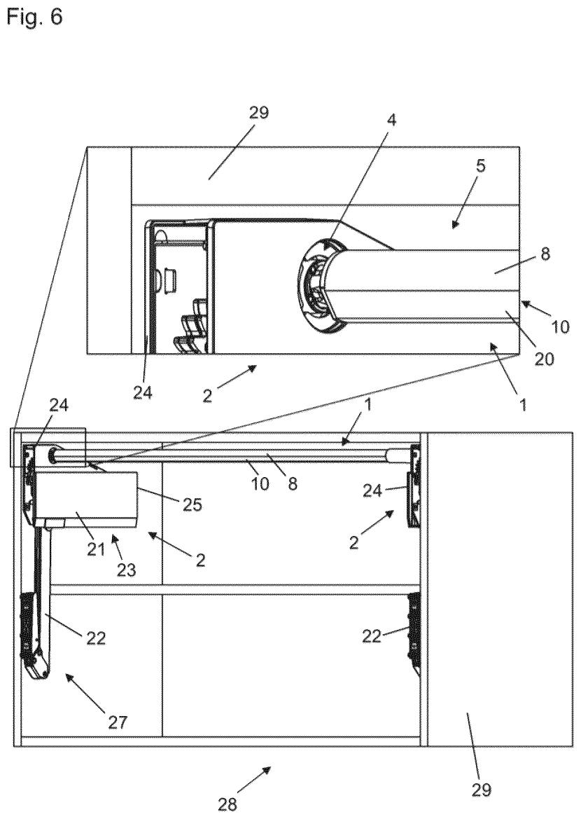

FIG. 6 shows the synchronization rod 1 in the closed position 27, wherein the inner contour 13 and the cross-section 7 of the synchronization region 5 are asymmetrical over the entire synchronization region 5.

The straight line 11 completely forms in its longitudinal extension 6 a flattening 20 of the synchronization region 5.

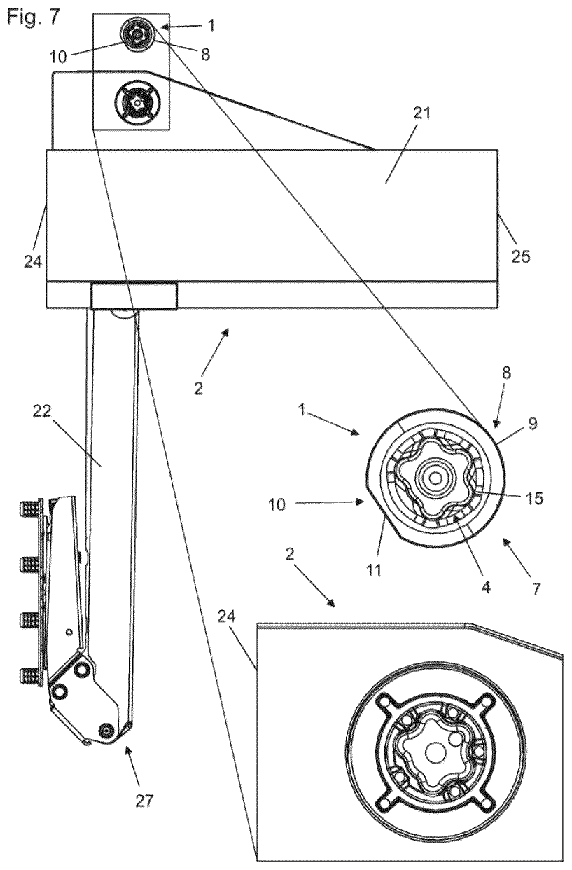

In FIG. 7, the furniture drive 2 is shown with the synchronization rod 1 removed, wherein in the detailed section of the synchronization rod 1 (above the receptacle of the furniture drive 2 corresponding to the coupling region 4) it can be seen that the coupling region 4 comprises a wave-shaped coupling contour 15.

The coupling contour 15 is mirror-symmetrical and has exclusively a 360° rotational symmetry, although in general a 180° rotational symmetry is also possible, for example. The flattened region of the coupling contour 15 can achieve a play-reducing synchronization.

FIG. 8 shows a perspective view of the furniture drive 2 with mounted synchronization rod 1, wherein the coupling region 4 comprises a plate-shaped coupling device 16.

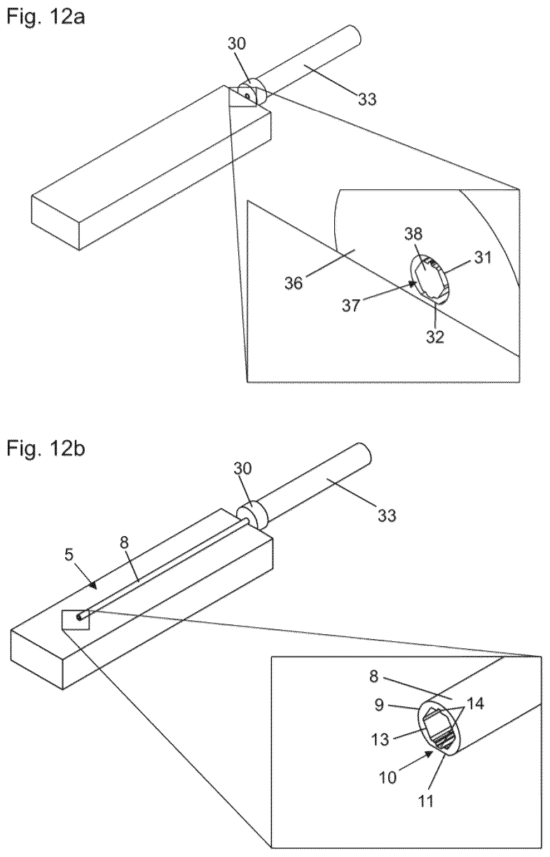

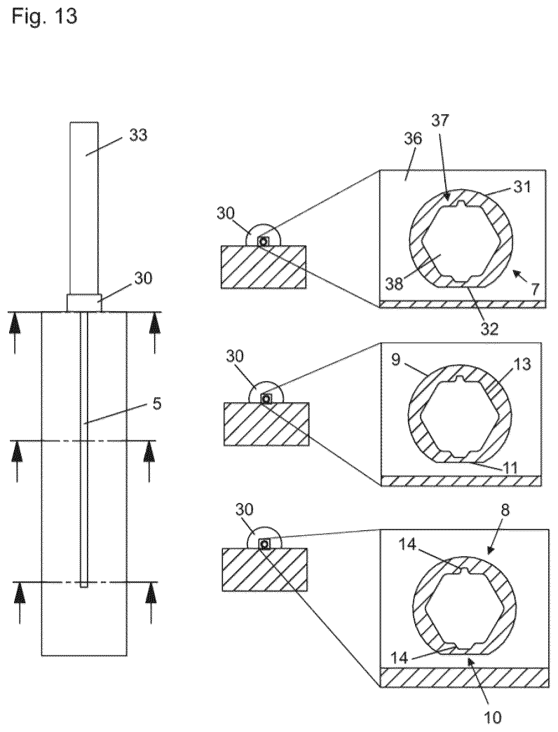

The synchronization region 5 is extruded, wherein a preferred manufacturing method is explained by FIGS. 12a to 13.

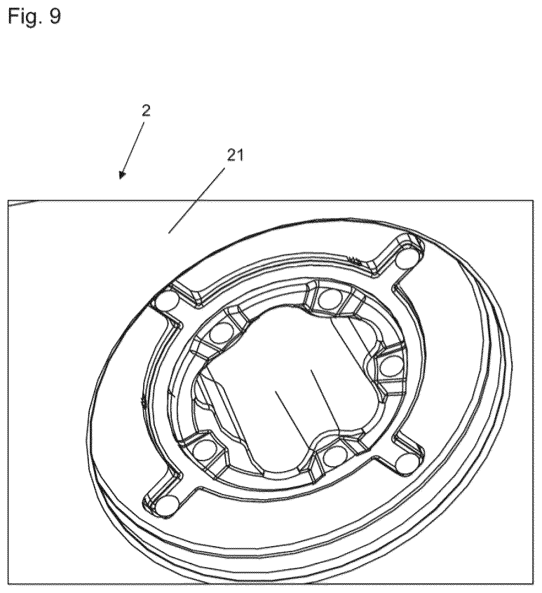

FIG. 9 shows the receptacle of the furniture drive 2 for connection to the coupling region 4 of the synchronization rod, wherein the receptacle is designed to correspond to the coupling region 4.

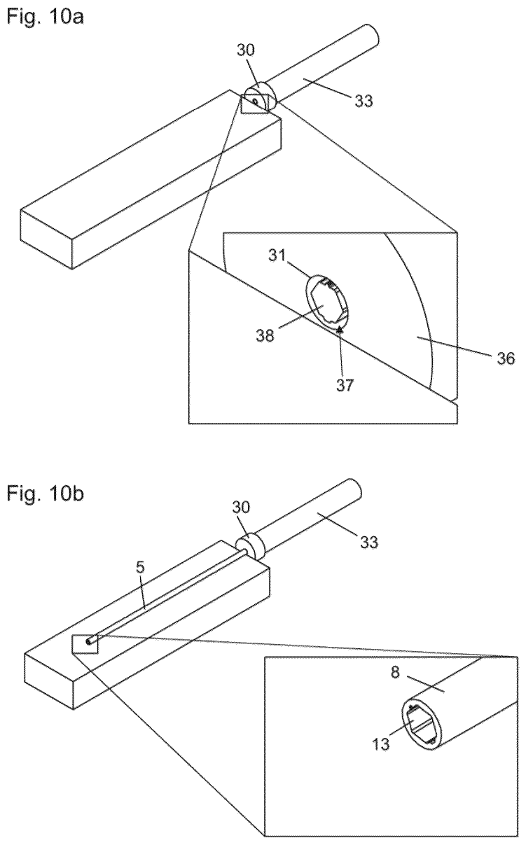

FIG. 10a shows an extrusion method of synchronization rods 1 not according to the invention, in which a rotationally symmetrical horizon of two dies 36, 37 of an extrusion mold is used to produce the synchronization region 5 in FIG. 10b.

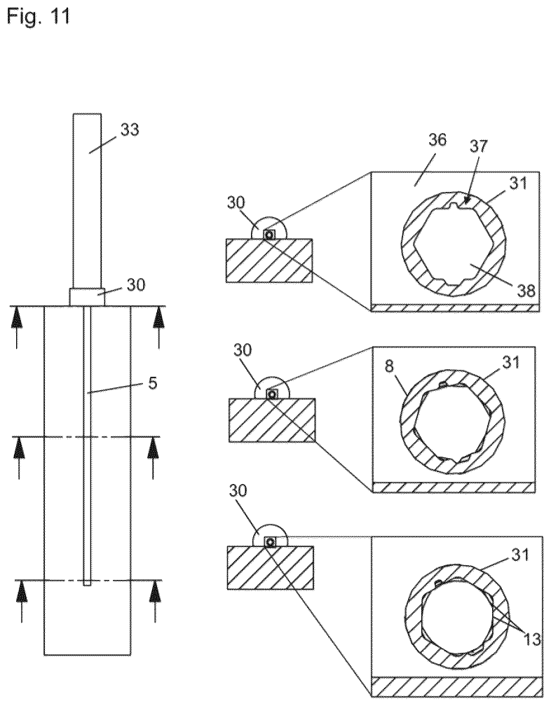

In FIG. 11, three sectional views along the synchronization region 5 show that during the extrusion process, the inner contour 13 is undesirably twisted along the synchronization region 5. This results in improper synchronization of the furniture drives 2.

FIG. 12a shows an extrusion method according to the invention of the synchronization region 5, wherein a twisting of the inner contour 13 is inhibited.

The extrusion mold 30 comprises for extrusion a first die 36 and a second die 37 separate from the first die 36-the number is generally arbitrary.

The second die 37 comprises a core 38 which projects into the first die 36 with the same horizon of the dies 36, 37 to form the two outer contour portions 8, 10 of the synchronization rod 1 and to form a substantially identical flow velocity of the raw material 30 over the dies 36, 37.

The method for producing the synchronization region 5 of the synchronization rod 1 can be exemplified by the following steps: providing the extrusion mold 30 shown in FIG. 12a with a first die contour 31 in the form of a circular segment 9 and a further die contour 32 adjacent to the first die contour 31, wherein the further die contour 32 has a geometry that differs from the first die contour 31—for example in the form of a flattened contour—and extruding a raw material 33 through the extrusion mold 30, as shown in FIG. 12b, and cutting it to length to form the synchronization region 5 with the desired dimensions.

The cutting to length is to be designed so broadly that a raw material 33 with a defined length is also used to produce the synchronization region 5 with the desired dimensions.

In this exemplary method, the raw material 33 is pre-tempered in a preparatory process step and the extruded raw material 33 is stretched using tongs to reduce bending before cutting to length and is then aged in an oven.

FIG. 13 shows, analogously to FIG. 11, three sectional views along the synchronization region 5, wherein it is evident in the associated enlarged detail sections that there is no twisting of the inner contour 13 due to the flattened die 36 with the further die contour 32 to form the further outer contour portion 10, whereby highly precise synchronization can be ensured—without reducing the visual appearance of the synchronization rod 1.

1. A synchronization rod for furniture drives for the synchronous movement of movable furniture parts, comprising:
at least one coupling region for connection to a furniture drive and a synchronization region along a longitudinal extension of the synchronization rod, in particular arranged between two opposite coupling regions,
wherein the synchronization region has, in a cross-section orthogonal to the longitudinal extension, a first outer contour portion in the form of a circular segment and at least one further outer contour portion, preferably adjacent to the first outer contour portion, with a geometry deviating from a circular segment,
wherein the circular segment comprises an angular range of between 250° and 330° and/or an angular range of between 180° and 350°,
wherein the further outer contour portion is arranged exclusively on one side of the synchronization rod.

2. The synchronization rod according to claim 1, wherein the at least one further outer contour portion comprises a straight line and/or is designed as at least one straight line adjacent to the circular segment.

3. The synchronization rod according to claim 1, wherein the cross-section of the synchronization region is mirror-symmetrical and/or has exclusively a 360° rotational symmetry, preferably 180° rotational symmetry.

4. The synchronization rod according to claim 1, wherein the at least one further outer contour portion comprises a preferably wave-shaped or polygon-like corrugation.

5. The synchronization rod according to claim 1, wherein the synchronization region comprises at least one, preferably polygonal, inner contour, preferably with at least one bulge, for synchronizing the furniture drives, wherein the inner contour is mirror-symmetrical and/or has exclusively a 360° rotational symmetry, preferably 180° rotational symmetry.

6. The synchronization rod according to claim 5, wherein the at least one inner contour and the cross-section of the synchronization region are formed asymmetrically over the entire synchronization region.

7. The synchronization rod according to claim 1, wherein the at least one coupling region comprises a preferably wave-shaped coupling contour and/or a plate-shaped coupling device, wherein it is preferably provided that the at least one coupling contour is mirror-symmetrical and/or has exclusively a 360° rotational symmetry, preferably 180° rotational symmetry.

8. The synchronization rod according to claim 1, wherein the synchronization region, preferably the synchronization rod, is extruded.

9. The synchronization rod according to claim 1, wherein the circular segment comprises an angular range between 290° and 320°.

10. The synchronization rod according to claim 2, wherein the at least one straight line is designed in the form of a polygonal line, preferably approximating a circular contour and/or as an alternating polygonal line.

11. The synchronization rod according to claim 2, wherein the at least one straight line in the longitudinal extension forms at least in portions, preferably completely, a flattening of the synchronization region.

12. An arrangement of at least two furniture drives, each with a drive device and at least one actuating arm for the synchronized movement of a movable furniture part and the synchronization rod according to claim 1, wherein the at least two furniture drives in the use position comprise a viewing region and a rear side and the actuating arms are movable between an open position and a closed position, wherein the at least one further outer contour portion in the open position of the actuating arms points in the direction of the rear side and/or in the closed position in the direction of the viewing region.

13. A piece of furniture with a furniture body and the arrangement according to claim 12.

14. A method for producing a synchronization region of the synchronization rod according to claim 1, comprising:
providing an extrusion mold with a first die contour in the form of a circular segment and at least one further die contour, in particular adjacent to the first die contour, wherein the at least one further die contour has a geometry that differs from the first die contour, preferably a straight geometry extruding a raw material through the extrusion mold and cutting to length to form the synchronization region.

15. The method according to claim 14, wherein the raw material is pre-tempered in a preparatory step and/or the extruded raw material is stretched, preferably via tongs, and/or aged in an oven before cutting to length.

16. The method according to claim 14, wherein the extrusion mold for extrusion comprises a first die and at least one second die separate from the first die, wherein it is preferably provided that the at least one second die comprises a core which projects at least partially into the first die, preferably with the same horizon of the dies and/or in order to form a substantially identical flow velocity of the raw material over the dies.
